(19) United States
(12) Patent Application Publication
(10) Pub. No.: US 2026/0270312 A1
(43) Pub. Date: Sep. 10, 2026

(54) HANDLING HIGH DEFINITION MAP DATA MESSAGES

(71) Applicant: QUALCOMM Incorporated, San Diego, CA (US)

(72) Inventors: Yifang MA, Shanghai (CN); Claus CHEN, Shanghai (CN); Teresa JIANG, Shanghai (CN)

(21) Appl. No.: 19/165,756

(22) PCT Filed: Mar. 31, 2023
(86) PCT No.: PCT/CN2023/085400

§ 371 Date: Sep. 16, 2025

(51) Int. Cl. H04L 67/12; H04L 69/164

(52) U.S. Cl. CPC H04L 67/12; H04L 69/164

(57) ABSTRACT

Various embodiments of methods and systems for handling high definition (HD) map data messages by a processing system of a vehicle include receiving in a first memory queue of the processing system via a User Datagram Protocol (UDP) a plurality of HD map data messages each comprising sequence information, storing a selected one of the HD map data messages in a second memory queue in response to determining that the sequence information of the selected HD map data message is greater than an expected sequence number, and processing the HD map data message stored in the second memory queue in response to the sequence information of the HD map data message stored in the second memory queue matching the expected sequence number.

### BACKGROUND

A high-definition map (HD map) is a highly accurate map that is widely used in autonomous driving systems (ADS) or advanced driver-assistance systems (ADAS). A vehicle may request HD map data from a network computing device, such as an Electronic Horizon Provider (EHP). The EHP may transmit the HD map data in a sequence of multiple HD map messages. However, the requesting vehicle may receive the HD map data message out of order due to network congestion, network routing, or another factor.

### SUMMARY

Various aspects include methods that may be performed by a vehicle processing system of a vehicle for handling HD map data messages. Various aspects include receiving in a first memory queue of the processing system via a User Datagram Protocol (UDP) a plurality of HD map data messages each comprising sequence information, storing a selected one of the HD map data messages in a second memory queue in response to determining that the sequence information of the selected HD map data message is greater than an expected sequence information, and processing the HD map data message stored in the second memory queue in response to the sequence information of the HD map data message stored in the second memory queue matching the expected sequence information.

Some aspects may include determining whether the second memory queue holds an HD map data message, and determining whether an HD map data message stored in the second memory queue matches the expected sequence information in response to determining that the second memory queue holds an HD map data message. Some aspects may include processing the HD map data message stored in the first memory queue in response to either determining that the second memory queue does not hold an HD map data message or determining that the sequence information of the HD map data message stored in the second memory queue does not match the expected sequence information. Some aspects may include discarding the selected one of the HD map data messages in response to determining that the sequence information of the selected HD map data message is less than the expected sequence information.

In some aspects, receiving in the first memory queue of the processing system via UDP the plurality of HD map data messages each including sequence information may include transmitting a request for HD map data to an Electronic Horizon Provider, and receiving the plurality of HD map data messages in response to the request for the HD map data. Some aspects may include starting a first timer after transmitting a request for HD map data to a network computing device configured to provide the HD map data, and transmitting a second request for HD map data to the network computing device in response to the first timer expiring before receiving an HD map data message.

Some aspects may include starting a second timer after receiving in the first memory queue of the processing system the plurality of HD map data messages, and determining that an HD map data message has been lost in response to the second timer expiring before the sequence information of an HD map data message stored in either of the first memory queue or the second memory queue matches the expected sequence information. In some aspects, the second memory queue may include a priority queue, and the sequence information of each of the HD map data messages stored in the second memory queue is processed as priority information of each of the HD map data messages stored in the second memory queue.

Further aspects include a processing system of a vehicle including a memory and a processor configured to perform operations of any of the methods summarized above. Further aspects may include a processing system of a vehicle having various means for performing functions corresponding to any of the methods summarized above. Further aspects may include a non-transitory processor-readable storage medium having stored thereon processor-executable instructions configured to cause a processing system of a vehicle to perform various operations corresponding to any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A is a system block diagram illustrating an example communication system suitable for implementing various embodiments.

FIG. 1B is a system block diagram illustrating an example disaggregated base station architecture suitable for implementing various embodiments.

FIG. 2A is a component diagram of an example vehicle processing system suitable for implementing various embodiments.

FIG. 2B is a component block diagram illustrating components of an example vehicle processing system suitable for implementing various embodiments.

FIG. 3 is a block diagram illustrating components of a system on chip suitable for use in a vehicle processing system in accordance with various embodiments.

FIG. 4A is a message flow diagram illustrating a method for handling HD map data messages in accordance with various embodiments.

FIG. 4B is a block diagram illustrating a method for handling HD map data messages in accordance with various embodiments.

FIG. 4C block diagram illustrating a first memory queue and a second memory queue configured to handle HD map data messages in accordance with various embodiments.

FIGS. 5A-5I are block diagrams illustrating operations that may be performed by a processor of a vehicle processing system for handling HD map data messages in accordance with various embodiments.

FIG. 6A is a process flow diagram of an example method performed by a processor of a vehicle processing system in a vehicle for handling HD map data messages in accordance with various embodiments.

FIG. 6B is a process flow diagram of an example method performed by a processor of a vehicle processing system in a vehicle for handling HD map data messages in accordance with various embodiments.

FIG. 6C is a process flow diagram of example operations that may be performed by a processor of a vehicle processing system in a vehicle as part of the method for handling HD map data messages in accordance with various embodiments.

FIG. 6D is a process flow diagram of example operations that may be performed by a processor of a vehicle processing system in a vehicle as part of the methods and operations for handling HD map data messages in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and vehicle processing systems configured to perform the methods of handling high definition (HD) map data messages. In various embodiments, a vehicle processing system may include one or more processors and/or other components configured to perform various operations for handling HD map data messages. In various embodiments, a vehicle processing system may receive HD map messages each including sequence information indicating a sequence of the HD map messages. The systems and methods enable the processing system of the vehicle to use two memory queues of the processing system to receive the HD map messages and process the HD map messages in their indicated sequence, even when the HD map message are received out of sequence. In this manner, the vehicle processing system may reduce or avoid the need to send a request to re-establish a communication link with the service provider computing device that transmits the HD map data messages.

As used herein, the term “vehicle” refers generally to any of an automobile, motorcycle, truck, bus, boat, and any other type of vehicle that may be configured with a processing system for managing driver engagement.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

A high-definition map (HD map) is a data structure that includes highly accurate map data, including information about road geometry, lanes, traffic signs and signals, and other suitable map data. HD map data also may be referred to as Electronic Horizon data. Autonomous driving systems (ADS) or advanced driver-assistance systems (ADAS) may use HD map data to perform various planning and maneuvering operations. The HD map data may be generated and provided to vehicle processing systems by a network computing device, such as an Electronic Horizon Provider (EHP), in several HD map data messages.

A vehicle processing system may be configured to perform operations to receive the HD map data messages from the network computing device and to assemble the HD map from information in the HD map data messages. In some embodiments, a function or module of the vehicle processing system, such as an Electronic Horizon Reconstructor (EHR) on the vehicle side, may receive the HD map data messages and reconstruct the HD map from the HD map data messages. The vehicle processing system also may be configured to perform operations to transform the information in the HD map data messages, or the HD map, transformed into a format usable by an ADS or ADAS system. For example, the vehicle processing system may perform operations to format the information in the HD map data messages, or the HD map, according to a data structure, format, syntax, or the like required by a particular ADS or ADAS system.

In some embodiments, a network computing device (e.g., of an HD map provider) and a vehicle processing system may communicate HD map data messages using the Uniform Datagram Protocol (UDP). UDP is a connectionless protocol in which the transmitting and receiving computing devices (e.g., the HD map data provider computing device and the vehicle computing system) do not establish a communication link before transmitting data. Rather, the computing device (e.g., a vehicle processing system) transmits a request for data (e.g., HD map data) to a provider computing device (e.g., an EHP network computing device), and the provider computing device responds by transmitting the requested data, e.g., to a specified port of the requesting computing device. However, computing devices using UDP do not implement error checking operations or flow control operations, nor does UDP include procedures for retransmission of lost or damaged packets. For at least these reasons, UDP enables the rapid transmission of HD map data messages without the network signaling and processing overhead incurred by, and without the transmission reliability provided by, communication link establishment (connection establishment), error checking, flow control, and retransmission processes.

Because UDP is a relatively unreliable protocol, HD map data messages may arrive at the vehicle processing system out of order (e.g., out of sequence), may be delivered more than once, or may not be received (e.g., lost or garbled). In conventional systems, when an out-of-order packet is detected (identified, determined), the receiving computing device may send another connection request to the network computing device that provides the HD map data messages, and in response the network computing device may resend the HD map data messages. In some embodiments, the network computing device may resend HD map data messages for a geographic area around the vehicle, resulting in a large and unnecessary transmission of HD map data messages (unnecessary because the HD map data messages were received albeit out of order).

Various embodiments may include methods and processing systems of a vehicle (vehicle processing systems) configured to implement the methods of handling HD map data messages. In some embodiments, the vehicle processing system may transmitting a request for HD map data to a network computing device (e.g., of an Electronic Horizon Provider). In response to the request for the HD map data, the vehicle processing system may receive in the first memory queue of the processing system via UDP the plurality of HD map data messages.

In some embodiments, the network computing device may configure (e.g., include or append) each HD map data message with sequence information, such as a sequence number on each message that indicates a location of each message in the sequence of HD map data messages. As a non-limiting example, a first HD map data message may be configured with or include a number (e.g., “0”), a second HD map data message may be configured with or include a subsequent number (e.g., “1”), and so on.

In some embodiments, the vehicle processing system may include a first memory queue that is configured to receive HD map data messages and store the messages in an order in which messages are received from the network computing device. In some embodiments, the vehicle processing system may be configured to process or handle HD map data messages in the first memory queue in a first-in, first-out (FIFO) manner. The vehicle processing system also may include a second memory queue, such as a priority queue.

In some embodiments, the vehicle processing system may be configured to process (handle, use) sequence information in each HD map data message as an indication of priority for storing HD map data message(s) in the second memory queue. In some embodiments, the vehicle processing system may configure the second memory queue to store HD map data messages in priority order, such as from a highest priority message (e.g., the message with the lowest sequence number) stored in a first memory location to a lowest priority message (e.g., the message with the highest sequence number) stored in a last memory location within the second memory queue. In some embodiments, the vehicle processing system may be configured to process or handle HD map data messages stored in the second memory queue in priority order, that is from highest priority (or lowest sequence number) to lowest priority (or highest sequence number).

In some embodiments, vehicle processing system may receive a plurality of HD map data messages via UDP and store such messages in the first memory queue of the processing system. Each of the HD map data messages may include sequence information. The vehicle processing system select one of the plurality of received HD map data messages and determine whether the sequence information of the selected HD map data message is greater than expected sequence information (e.g., an expected sequence number). The vehicle processing system may store the selected HD map data message in the second memory queue in response to determining that the sequence information of the selected HD map data message is greater than the expected sequence information (e.g., an expected sequence number). The vehicle processing system may process the HD map data message stored in the second memory queue in response to the sequence information of the HD map data message stored in the second memory queue matching the expected sequence information. In some embodiments, the vehicle processing system may determine whether the second memory queue holds an HD map data message, and determine whether an HD map data message stored in the second memory queue matches the expected sequence information in response to determining that the second memory queue holds an HD map data message.

In some embodiments, the vehicle processing system may process an HD map data message stored in the first memory queue in response to determining that the second memory queue does not hold an HD map data message. In some embodiments, the vehicle processing system may process an HD map data message stored in the first memory queue in response to determining that the sequence information of the HD map data message stored in the second memory queue does not match the expected sequence information. In some embodiments, the vehicle processing system may discard the selected one of the HD map data messages in response to determining that the sequence information of the selected HD map data message is less than the expected sequence information.

In some embodiments, the vehicle processing system may start a first timer after transmitting a request for HD map data to a network computing device configured to provide the HD map data (e.g., an Electronic Horizon Provider (EHP)). The vehicle processing system may transmit a second request for HD map data to the network computing device in response to the first timer expiring before receiving an HD map data message.

In some embodiments, the vehicle processing system may start a second timer after receiving in the first memory queue of the processing system the plurality of HD map data messages. The vehicle processing system may determine that an HD map data message has been lost in response to the second timer expiring before the sequence information of an HD map data message stored in either of the first memory queue or the second memory queue matches the expected sequence information.

Various embodiments improve the efficiency and speed of operation of vehicles by enabling vehicle processing systems to handle HD map data messages that are received out of order without the need for requesting second (or subsequent) transmissions of some HD map data messages from the network computing device that provides the HD map data messages. Various embodiments improve the safety of operation of vehicles by enabling vehicle processing systems to more rapidly assemble HD map data from HD map data messages, providing the information in the HD map data more rapidly to the vehicle processing systems. Various embodiments improve the efficiency of operation of communication networks handling HD map data by reducing a volume of superfluous HD map data messages transported by the network.

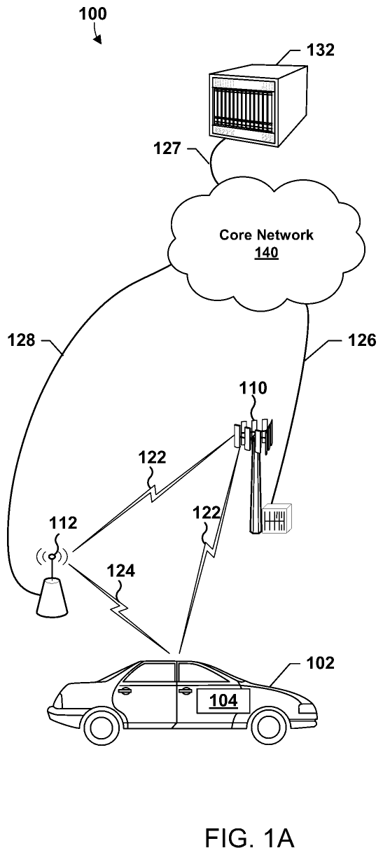

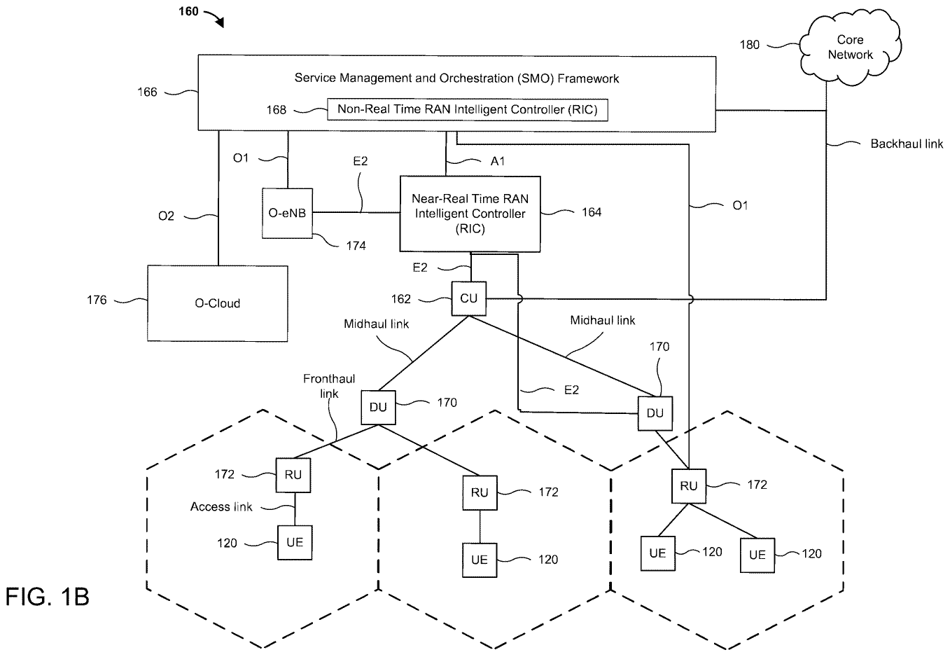

FIG. 1A is a system block diagram illustrating an example communication system 100 suitable for implementing the various embodiments. The communications system 100 include a 5G New Radio (NR) network, an Intelligent Transportation System (ITS) V2X wireless network, and/or any other suitable network such as a Long Term Evolution (LTE) network. References to a 5G network and 5G network elements in the following descriptions are for illustrative purposes and are not intended to be limiting.

The communications system 100 may include a heterogeneous network architecture that includes a core network 140, a number of base stations 110, and a variety of mobile devices including a vehicle 102 equipped with a vehicle processing system 104 that includes wireless communication capabilities. The base station 110 may communicate with a core network 140 over a wired communication link 126. The communications system 100 also may include roadside units 112 supporting V2X communications with vehicles 102 via V2X wireless communication links 124.

A base station 110 is a network element that communicates with wireless devices (e.g., a vehicle processing system 104 of the vehicle 102) via a wireless communication link 122, and may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station 110 may provide communication coverage for a particular geographic area or “cell.” In 3GPP, the term “cell” can refers to a coverage area of a base station, a base station subsystem serving this coverage area, or a combination thereof, depending on the context in which the term is used. The core network 140 may be any type of core network, such as an LTE core network (e.g., an evolved packet core (EPC) network), 5G core network, a disaggregated network as described with reference to FIG. 1B, etc.

Roadside units 112 may communicate with the core network 140 via a wired or wireless communication link 128. Roadside units 112 may communicate via V2X wireless communication links 124 with vehicle processing system-equipped vehicles 102 for downloading information useful for vehicle processing system autonomous and semi-autonomous driving functions, and for receiving information such as misbehavior reports from the vehicle processing system 104.

A network computing device 132 may communicate with the core network 140 via a wired or wireless communication link 127. The network computing device 132 may receive requests from the vehicle processing system 104 for HD map data. The network computing device 132 may transmit HD map data messages in response to request(s) from the vehicle processing system 104.

Wireless communication links 122 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

FIG. 1B is a system block diagram illustrating an example disaggregated base station 160 architecture that may be part of a V2X and/or 5G network suitable for communicating map data to vehicles and communicating updated object/feature location data according to any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, user equipment (UE), such as a vehicle processing system 104, may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an Al interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as Al policies).

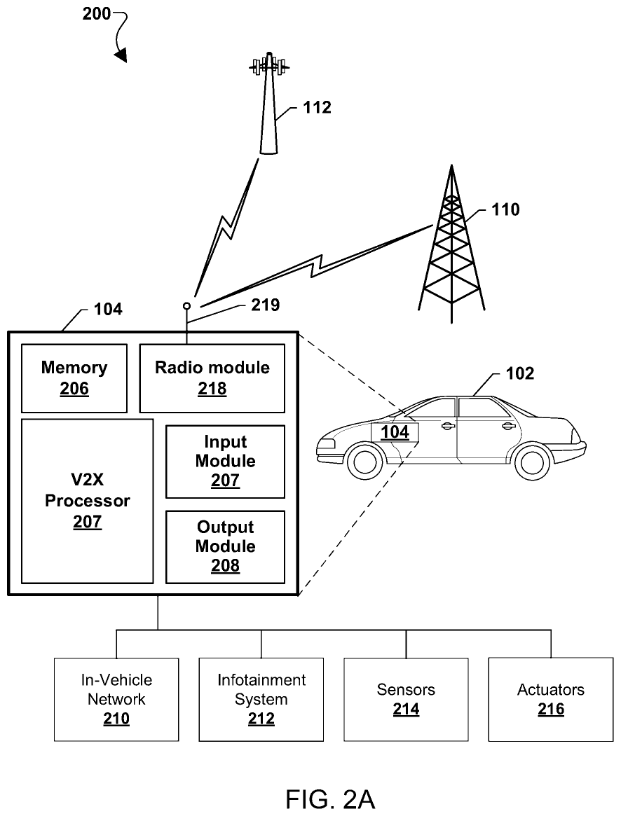

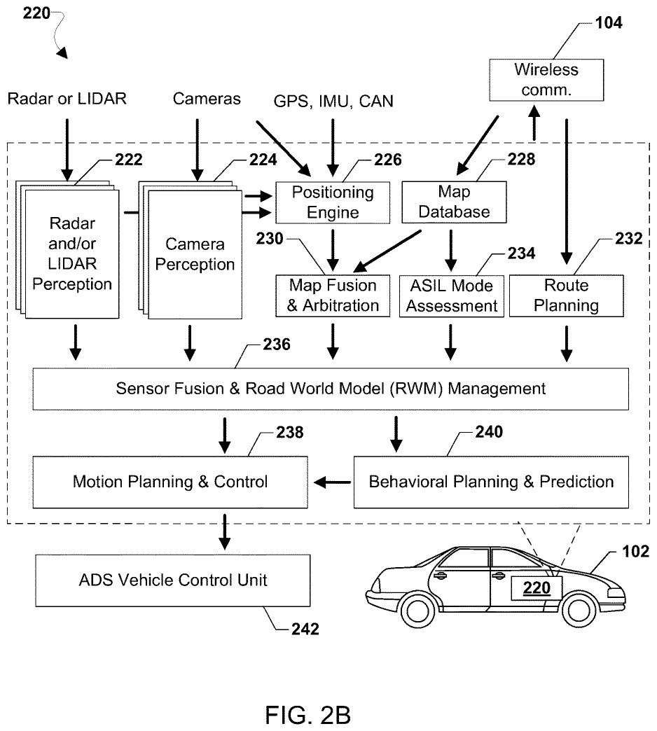

FIG. 2A is a component diagram of an example vehicle processing system 200 suitable for implementing various embodiments. With reference to FIGS. 1A-2A, the processing system 200 may include a vehicle 102 that includes a vehicle processing system 104. The vehicle processing system 104 may communicate with various systems and devices, such as an in-vehicle network 210, an infotainment system 212, various sensors 214, various actuators 216, and a radio module 218 coupled to an antenna 219. The vehicle processing system 104 also may communicate with roadside units 112, cellular communication network base stations 110, and other external devices.

The vehicle processing system 104 may include a processor 205, memory 206, an input module 207, an output module 208 and the radio module 218. The processor 205 may be coupled to the memory 206 (i.e., a non-transitory storage medium), and may be configured with processor-executable instructions stored in the memory 206 to perform operations of the methods according to various embodiments described herein. Also, the processor 205 may be coupled to the output module 208, which may control in-vehicle displays, and to the input module 207 to receive information from vehicle sensors as well as driver inputs.

The vehicle processing system 104 may include a V2X antenna 219 coupled to the radio module 218 that is configured to communicate with one or more ITS participants (e.g., stations), a roadside unit 112, and a base station 110 or another suitable network access point. The V2X antenna 219 and radio module 218 may be configured to receive dynamic traffic flow feature information via vehicle-to-everything (V2X) communications. In various embodiments, the vehicle processing system may receive information from a plurality of information sources, such as the in-vehicle network 210, infotainment system 212, various sensors 214, various actuators 216, and the radio module 218. The vehicle processing system may be configured to perform autonomous or semi-autonomous driving functions using map data in addition to sensor data, as further described below.

Examples of an in-vehicle network 210 include a Controller Area Network (CAN), a Local Interconnect Network (LIN), a network using the FlexRay protocol, a Media Oriented Systems Transport (MOST) network, and an Automotive Ethernet network. Examples of vehicle sensors 214 include a location determining system (such as a Global Navigation Satellite Systems (GNSS) system, a camera, and other suitable sensor devices and systems. Examples of vehicle actuators 216 include various physical control systems such as for steering, brakes, engine operation, lights, directional signals, and the like.

FIG. 2B is a component block diagram illustrating components of an example vehicle processing system 220 suitable for implementing various embodiments. With reference to FIGS. 1A-2B, the vehicle processing system 220, which may include an autonomous or semiautonomous driving system, may be coupled to the vehicle processing system 104. The vehicle processing system 220 may include various subsystems, communication elements, computational elements, computing devices or units which may be utilized within a vehicle 102. The various computational elements, computing devices or units within the vehicle processing system 220 may be implemented within a system of computing devices (i.e., subsystems) that communicate data and commands to each other via the in-vehicle network 210 (e.g., indicated by the arrows in FIG. 2B). In some implementations, the various computational elements, computing devices or units within the vehicle processing system 220 may be implemented within a single computing device, such as separate threads, processes, algorithms or computational elements. Therefore, each subsystem/computational element illustrated in FIG. 2B is also generally referred to herein as a “layer” within a computational “stack” that constitutes the vehicle processing system 220. However, the use of the terms layer and stack in describing various embodiments are not intended to imply or require that the corresponding functionality is implemented within a single vehicle computing device, although that is a potential implementation embodiment. Rather the use of the term “layer” is intended to encompass subsystems with independent processors, computational elements (e.g., threads, algorithms, subroutines, etc.) running in one or more computing devices, and combinations of subsystems and computational elements.

The vehicle processing system 220 may include a sensor perception layer 222, a camera perception layer 224, a positioning engine layer 226, a map database 228, a map fusion and arbitration layer 230, a route planning layer 232, an operating mode assessment layer 234, a sensor fusion and road world model (RWM) management layer 236, a motion planning and control layer 238, and a behavioral planning and prediction layer 240. The layers 222-240 are merely examples of some layers in one example configuration of the vehicle processing system 220. In other configurations, other layers may be included, such as additional layers for other perception sensors (e.g., a lidar perception layer, etc.), additional layers for planning and/or control, additional layers for modeling, etc., and/or certain of the layers 222-240 may be excluded from the vehicle processing system 220. Each of the layers 222-240 may exchange data, computational results and commands as illustrated by the arrows in FIG. 2B.

Further, the vehicle processing system 220 may receive and process data from sensors (e.g., cameras, inertial measurement units (IMU) etc.), navigation information sources (e.g., Global Positioning System (GPS) receivers, IMUs, etc.), vehicle networks (e.g., Controller Area Network (CAN) bus), and databases in memory (e.g., digital map or HD map data).

The vehicle processing system 220 may output vehicle control commands or signals to an autonomous driving system (ADS) vehicle control unit 242, which is a system, subsystem or computing device that interfaces directly with vehicle steering, throttle and brake controls. The configuration of the vehicle processing system 220 and ADS vehicle control unit 242 illustrated in FIG. 2A is merely an example configuration and other configurations of a vehicle management system and other vehicle components may be used. As an example, the configuration of the vehicle processing system 220 and ADS vehicle control unit 242 illustrated in FIG. 2B may be used in a vehicle configured for autonomous or semi-autonomous operation while a different configuration may be used in a non-autonomous vehicle.

The sensor perception layer 222 may receive data from one or more detection and ranging sensors, and process the data to recognize and determine locations of other vehicles and objects within a vicinity of the vehicle 102. The sensor perception layer 222 may include use of neural network processing and artificial intelligence methods to recognize objects and vehicles, and pass such information on to the sensor fusion and RWM management layer 236.

The camera perception layer 224 may receive data from one or more cameras, such as cameras, and process the data to recognize and determine locations of other vehicles and objects within a vicinity of the vehicle 102. The camera perception layer 224 may include use of neural network processing and artificial intelligence methods to recognize objects and vehicles, and pass such information on to the sensor fusion and RWM management layer 236.

The positioning engine layer 226 may receive data from the sensor perception layer 222, the camera perception layer 224, and various sources of navigation information, and process the data and information to determine a position of the vehicle 102. Various sources of navigation information may include, but is not limited to, a GPS receiver, an IMU, and/or other sources and sensors connected via a CAN bus. The positioning engine layer 226 may also utilize inputs from one or more cameras, such as cameras and/or any other available sensor capable of identifying and determining directions and distances to objects in the vicinity of the vehicle.

The vehicle processing system 220 may include or be coupled to a vehicle processing system 104 according to various embodiments. One or more of the layers 222-240 may provide information to or receive information from the vehicle processing system 104. The vehicle processing system 104 may be configured to communicate with highway communication systems, such as via V2X communication links (e.g., 124) and/or to remote information sources (e.g., computing device 132) via cellular wireless communication links (e.g., 122), such as via 5G cellular networks.

The map fusion and arbitration layer 230 may access the map database 228 for location information regarding nearby objects and features, and receive localizing/navigation information output from the positioning engine layer 226, and process the data to further determine the position of the vehicle 102 within the map, such as location within a lane of traffic, position within a street map, etc. sensor data may be stored in a memory (e.g., memory 312).

Similar to location information in some map objects and features and sensor accuracy and precision, GPS position fixes include some error, so the map fusion and arbitration layer 230 may function to determine a best guess location of the vehicle within a roadway based upon an arbitration between the GPS coordinates, sensor data, and map data regarding objects and features in and near the roadway. For example, while GPS coordinates may place the vehicle near the middle of a two-lane road in the sensor data, the map fusion and arbitration layer 230 may determine from the direction of travel that the vehicle is most likely aligned with the travel lane consistent with the direction of travel. The map fusion and arbitration layer 230 may pass arbitrated map location information to the sensor fusion and RWM management layer 236.

The route planning layer 232 may utilize sensor data, as well as inputs from an operator or dispatcher to plan a route to be followed by the vehicle 102 to a particular destination. The route planning layer 232 may pass map-based location information to the sensor fusion and RWM management layer 236. However, the use of a prior map by other layers, such as the sensor fusion and RWM management layer 236, etc., is not required. For example, other stacks may operate and/or control the vehicle based on perceptual data alone without a provided map, constructing lanes, boundaries, and the notion of a local map as perceptual data is received.

In embodiments including an operating mode assessment layer 234, that processing layer may use safety and/or confidence information regarding nearby objects and features to select an appropriate ADS driving mode. In some embodiments, the operating mode assessment layer 234 may determine whether the current autonomous or semi-autonomous driving mode is consistent with or appropriate in view of safety and/or confidence information regarding nearby objects and features in the driving environment.

The sensor fusion and RWM management layer 236 may receive data and outputs produced by the sensor perception layer 222, camera perception layer 224, map fusion and arbitration layer 230, route planning layer 232, and the operating mode assessment layer 234, and use some or all of such inputs to estimate or refine the location and state of the vehicle 102 in relation to the road, other vehicles on the road, and other objects within a vicinity of the vehicle 102. For example, the sensor fusion and RWM management layer 236 may combine imagery data from the camera perception layer 224 with arbitrated map location information from the map fusion and arbitration layer 230 to refine the determined position of the vehicle within a lane of traffic. As another example, the sensor fusion and RWM management layer 236 may combine object recognition and imagery data from the camera perception layer 224 with object detection and ranging data from the sensor perception layer 222 to determine and refine the relative position of other vehicles and objects in the vicinity of the vehicle. As another example, the sensor fusion and RWM management layer 236 may receive information from V2X communications (such as via the CAN bus) regarding other vehicle positions and directions of travel, and combine that information with information from the sensor perception layer 222 and the camera perception layer 224 to refine the locations and motions of other vehicles. The sensor fusion and RWM management layer 236 may output refined location and state information of the vehicle 102, as well as refined location and state information of other vehicles and objects in the vicinity of the vehicle, to the motion planning and control layer 238 and/or the behavior planning and prediction layer 240.

As a further example, the sensor fusion and RWM management layer 236 may use dynamic traffic control instructions directing the vehicle 102 to change speed, lane, direction of travel, or other navigational element(s), and combine that information with other received information to determine refined location and state information. The sensor fusion and RWM management layer 236 may output the refined location and state information of the vehicle 102, as well as refined location and state information of other vehicles and objects in the vicinity of the vehicle 102, to the motion planning and control layer 238, the behavior planning and prediction layer 240 and/or devices remote from the vehicle 102, such as a data server, other vehicles, etc., via wireless communications, such as through C-V2X connections, other wireless connections, etc.

As a still further example, the sensor fusion and RWM management layer 236 may monitor perception data from various sensors, such as perception data from a sensor perception layer 222, camera perception layer 224, other perception layer, etc., and/or data from one or more sensors themselves to analyze conditions in the vehicle sensor data. The sensor fusion and RWM management layer 236 may be configured to detect conditions in the sensor data, such as sensor measurements being at, above, or below a threshold, certain types of sensor measurements occurring, etc., and may output the sensor data as part of the refined location and state information of the vehicle 102 provided to the behavior planning and prediction layer 240 and/or devices remote from the vehicle 102, such as a data server, other vehicles, etc., via wireless communications, such as through C-V2X connections, other wireless connections, etc.

The behavioral planning and prediction layer 240 of the autonomous vehicle processing system 220 may use the refined location and state information of the vehicle 102 and location and state information of other vehicles and objects output from the sensor fusion and RWM management layer 236 to predict future behaviors of other vehicles and/or objects. For example, the behavioral planning and prediction layer 240 may use such information to predict future relative positions of other vehicles in the vicinity of the vehicle based on own vehicle position and velocity and other vehicle positions and velocity. Such predictions may take into account information from the map data and route planning to anticipate changes in relative vehicle positions as host and other vehicles follow the roadway. The behavioral planning and prediction layer 240 may output other vehicle and object behavior and location predictions to the motion planning and control layer 238.

Additionally, the behavior planning and prediction layer 240 may use object behavior in combination with location predictions to plan and generate control signals for controlling the motion of the vehicle 102. For example, based on route planning information, refined location in the roadway information, and relative locations and motions of other vehicles, the behavior planning and prediction layer 240 may determine that the vehicle 102 needs to change lanes and accelerate, such as to maintain or achieve minimum spacing from other vehicles, and/or prepare for a turn or exit. As a result, the behavior planning and prediction layer 240 may calculate or otherwise determine a steering angle for the wheels and a change to the throttle setting to be commanded to the motion planning and control layer 238 and ADS vehicle control unit 242 along with such various parameters necessary to effectuate such a lane change and acceleration. One such parameter may be a computed steering wheel command angle.

The motion planning and control layer 238 may receive data and information outputs from the sensor fusion and RWM management layer 236, map data from the map database 232, and other vehicle and object behavior as well as location predictions from the behavior planning and prediction layer 240, and use this information to plan and generate control signals for controlling the motion of the vehicle 102 and to verify that such control signals meet safety requirements for the vehicle 102. For example, based on route planning information, refined location in the roadway information, and relative locations and motions of other vehicles, the motion planning and control layer 238 may verify and pass various control commands or instructions to the ADS vehicle control unit 242.

The ADS vehicle control unit 242 may receive the commands or instructions from the motion planning and control layer 238 and translate such information into mechanical control signals for controlling wheel angle, brake and throttle of the vehicle 102. For example, ADS vehicle control unit 242 may respond to the computed steering wheel command angle by sending corresponding control signals to the steering wheel controller.

In various embodiments, the vehicle processing system 104 may communicate with other vehicle processing system participants (e.g., other vehicles, roadside units, etc.) via wireless communication links to transmit sensor data, position data, vehicle data and data gathered about the environment around the vehicle by onboard sensors. Such information may be used by other vehicle processing system participants to update stored sensor data for relay to other vehicle processing system participants.

In various embodiments, the vehicle processing system 220 may include functionality that performs safety checks or oversight of various commands, planning or other decisions of various layers that could impact vehicle and occupant safety. Such safety check or oversight functionality may be implemented within a dedicated layer or distributed among various layers and included as part of the functionality. In some embodiments, a variety of safety parameters may be stored in memory and the safety checks or oversight functionality may compare a determined value (e.g., relative spacing to a nearby vehicle, distance from the roadway centerline, etc.) to corresponding safety parameter(s), and issue a warning or command if the safety parameter is or will be violated. For example, a safety or oversight function in the behavior planning and prediction layer 240 (or in a separate layer) may determine the current or future separate distance between another vehicle (as defined by the sensor fusion and RWM management layer 236) and the vehicle (e.g., based on the world model refined by the sensor fusion and RWM management layer 236), compare that separation distance to a safe separation distance parameter stored in memory, and issue instructions to the motion planning and control layer 238 to speed up, slow down or turn if the current or predicted separation distance violates the safe separation distance parameter. As another example, safety or oversight functionality in the motion planning and control layer 238 (or a separate layer) may compare a determined or commanded steering wheel command angle to a safe wheel angle limit or parameter, and issue an override command and/or alarm in response to the commanded angle exceeding the safe wheel angle limit.

Some safety parameters stored in memory may be static (i.e., unchanging over time), such as maximum vehicle speed. Other safety parameters stored in memory may be dynamic in that the parameters are determined or updated continuously or periodically based on vehicle state information and/or environmental conditions. Non-limiting examples of safety parameters include maximum safe speed, maximum brake pressure, maximum acceleration, and the safe wheel angle limit, all of which may be a function of roadway and weather conditions.

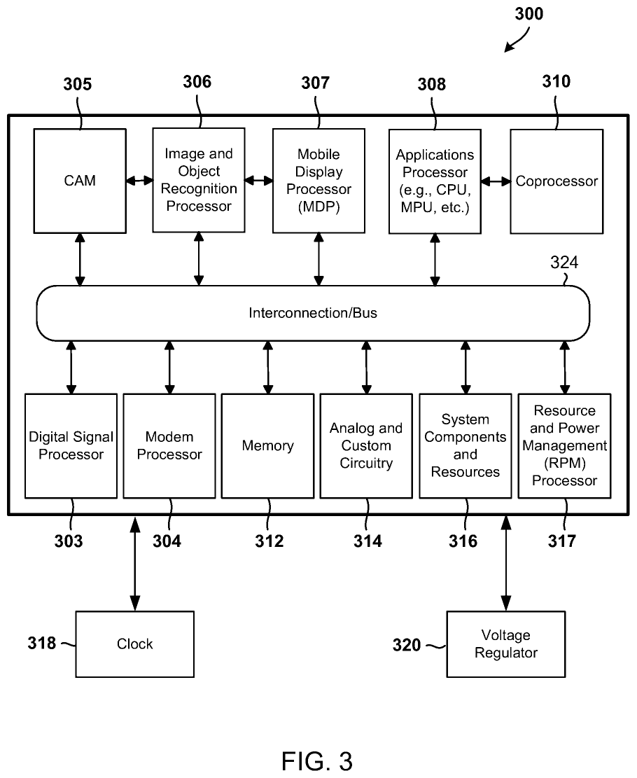

FIG. 3 is a block diagram illustrating an example components of a system on chip (SOC) 300 suitable for use in a vehicle processing system in accordance with various embodiments. With reference to FIGS. 1A-3, the processing device SOC 300 may include a number of heterogeneous processors, such as a digital signal processor (DSP) 303, a modem processor 304, an image and object recognition processor 306, a mobile display processor 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317.

Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry for camera actuation and management (CAM) 305 that includes, provides, controls and/or manages the operations of one or more cameras (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras via the CAM 305 to recognize and/or identify other vehicles, and otherwise perform functions of the camera perception layer 224 as described. In some embodiments, the processor 306 may be configured to process external sensor data and perform functions of the sensor perception layer 222 as described.

The system components and resources 316, analog and custom circuitry 314, and/or CAM 305 may include circuitry to interface with peripheral devices, such as cameras, external sensors, electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.).

In some embodiments, the processing device SOC 300 may be included in a control unit (e.g., 140) for use in a vehicle (e.g., 100). The control unit may include communication links for communications with a telephone network (e.g., 180), the Internet, and/or a network server (e.g., 184) as described.

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well-known components of modern electronic devices.

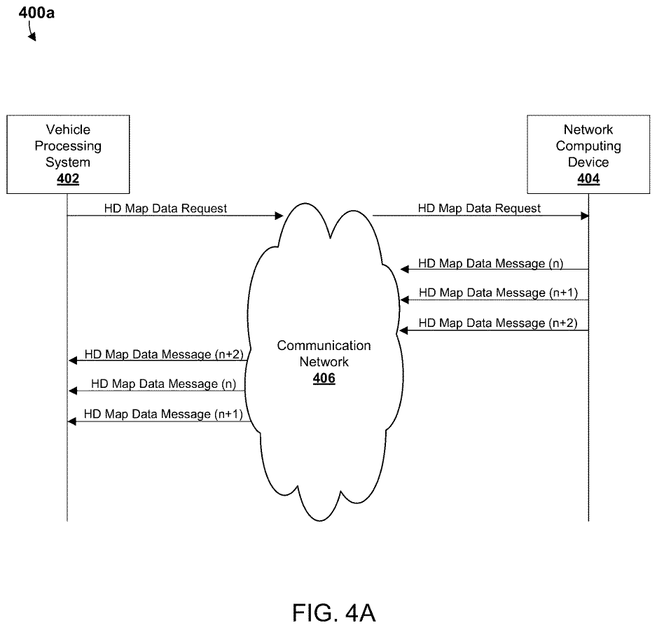

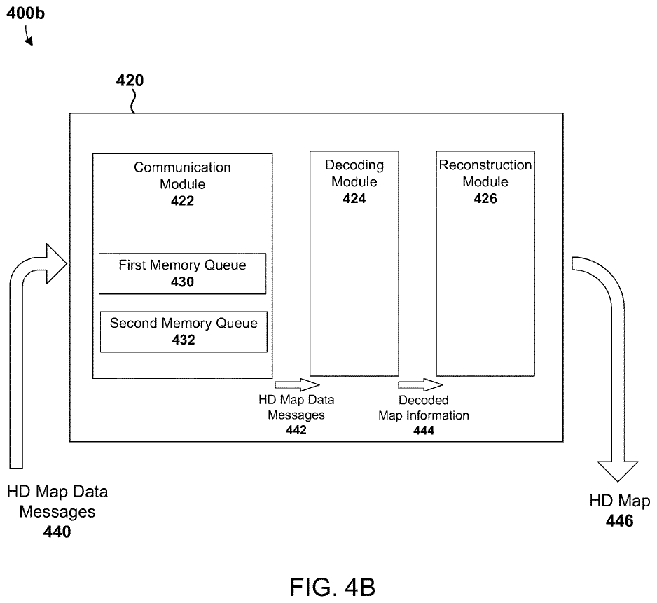

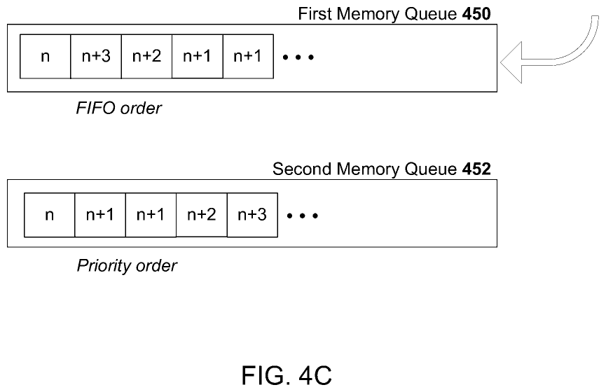

FIG. 4A is a message flow diagram illustrating a method 400a for handling HD map data messages in accordance with various embodiments. With reference to FIGS. 1A-4A, various operations of the method 400a may be performed by a processor (e.g., 207, 303, 304, 306, 307, 308, 310) of a vehicle processing system 402 or a network computing device 404. Various operations of the method 400a may be implemented in software processing modules that execute in a vehicle computing device, within dedicated hardware modules within the vehicle, or in combinations of software processing modules and dedicated hardware modules that make up the vehicle processing system 402 or network computing device 404.

A vehicle processing system 402 may transmit an HD map data request to the network computing device 404 via a communication network 406. In some embodiments, the HD map data request may include or be included in a connection request (e.g., a UDP connection request). In some embodiments, the vehicle processing system 402 may start a timer after transmitting the HD map data request. In response to determining that the timer has expired before receiving an HD map data message, the vehicle processing system 402 may transmit a second request for HD map data to the network computing device 404.

The network computing device 404 may receive the HD map data request, and in response may transmit one or more HD map data messages in a sequence, for example n, n+1, n+2, etc., via the communication network 406. Due to a variety of conditions in the communication network 406, including routing and network paths traveled by the HD map data messages, network congestion, and the like, the vehicle processing system 402 may receive the HD map data messages in an order that is different from the transmitted sequence (i.e., out of order). For example, the vehicle processing system 402 may receive the HD map data messages in an order n+2, n, n+1, and so forth.

FIG. 4B is a block diagram illustrating a method 400b for handling HD map data messages in accordance with various embodiments. With reference to FIGS. 1A-4B, various operations of the method 400b may be performed by a processor (e.g., 207, 303, 304, 306, 307, 308, 310) of a vehicle processing system 420 or a network computing device 404. The vehicle processing system 420 may include a communication module 422, a decoding module 424, and a reconstruction module 426. The communication module 422, decoding module 424, and reconstruction module 426 may be configured to perform various operations of the method 400b, and may be implemented in software processing modules that execute in a vehicle computing device, within dedicated hardware modules within the vehicle, or in combinations of software processing modules and dedicated hardware modules that make up the vehicle processing system 420. In some embodiments, the vehicle processing system 420 may include an Electronic Horizon Reconstructor (EHR).

In various embodiments, HD map data messages 440 may be received in the vehicle processing system 420 by the communication module 422. The communication module 422 may store the HD map data messages 440 and a first memory queue 430 and/or a second memory queue 432 as further described herein. The decoding module 424 may perform operations to obtain HD map data messages 440 stored in the first memory queue 430 and/or the second memory queue 432. The decoding module 424 may perform operations to decode information in the HD map data messages, and may transmit 444 decoded map information to the reconstruction module 426. The reconstruction module 426 may perform operations using the decoded map information to reconstruct a data structure such as an HD map 446. The reconstruction module may transmit as output the reconstructed HD map 446 to one or more vehicle systems (e.g., an ADS, ADAS, or other suitable system) that may use the HD map 446 to perform vehicle operations, such as planning, maneuver, or another suitable vehicle operation.

FIG. 4C is a block diagram illustrating a first memory queue 450 and a second memory queue 452 configured to handle HD map data messages in accordance with various embodiments. With reference to FIGS. 1A-4C, various operations of the method 400b may be performed by a processor (e.g., 207, 303, 304, 306, 307, 308, 310) of a vehicle processing system 420 or a network computing device 404. The first memory queue 450 and the second memory queue 452 may be implemented in a vehicle processing system (e.g., 104, 200, 402, 420) in software processing modules that execute in a vehicle computing device, within dedicated hardware modules within the vehicle, or in combinations of software processing modules and dedicated hardware modules that make up the vehicle processing system.

In some embodiments, the vehicle processing system may receive HD map data messages that are configured (e.g., by a network computing device) with sequence information, such as a sequence number that indicates a sequence of the HD map data messages. The first memory queue 450 may be configured to receive and store HD map data messages in an order in which the HD map data messages are received, which may be out of a sequence in which the messages were transmitted, e.g., having sequence information n, n+3, n+2, n+1, etc. Further, the first memory queue 450 may receive and store duplicates of HD map data messages (e.g., two HD map data messages having the sequence information n+1). In some embodiments, the first memory queue 450 may be configured to handle the HD map data messages a first-in, first-out (FIFO) manner.

In some embodiments, the second memory queue 452 may be configured as a priority queue that is configured to process (handle, use) sequence information in each HD map data message as an indication of priority for storing HD map data message(s) in the second memory queue 452. In some embodiments, the second memory queue 452 may be configured to store HD map data messages in priority order, from highest priority first (e.g., lowest sequence number first) to lowest priority last (e.g., highest sequence number last). For example, the second memory queue 452 may store received HD map data messages in a priority order n, n+1, n+2, n+3, etc. In some embodiments, the vehicle processing system may be configured to process or handle HD map data messages in the second memory queue 452 in priority order, from highest priority to lowest priority.

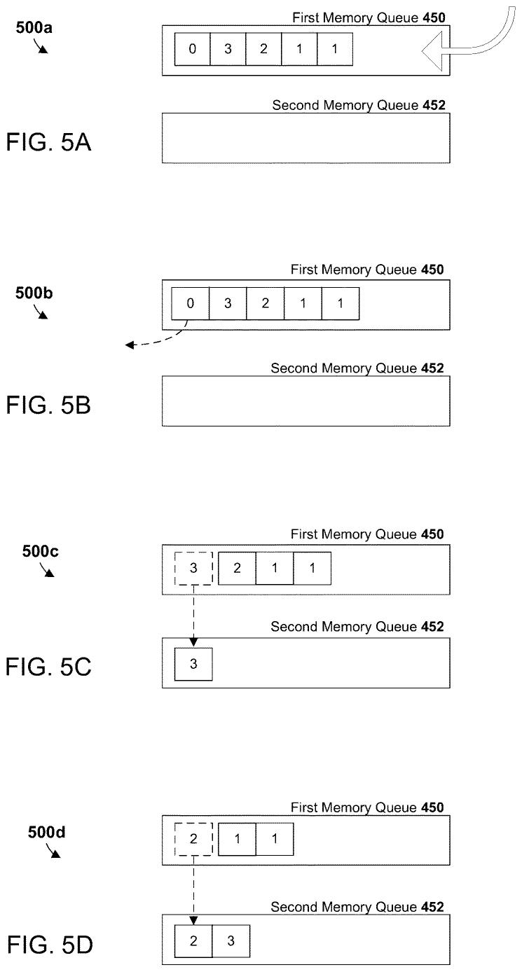

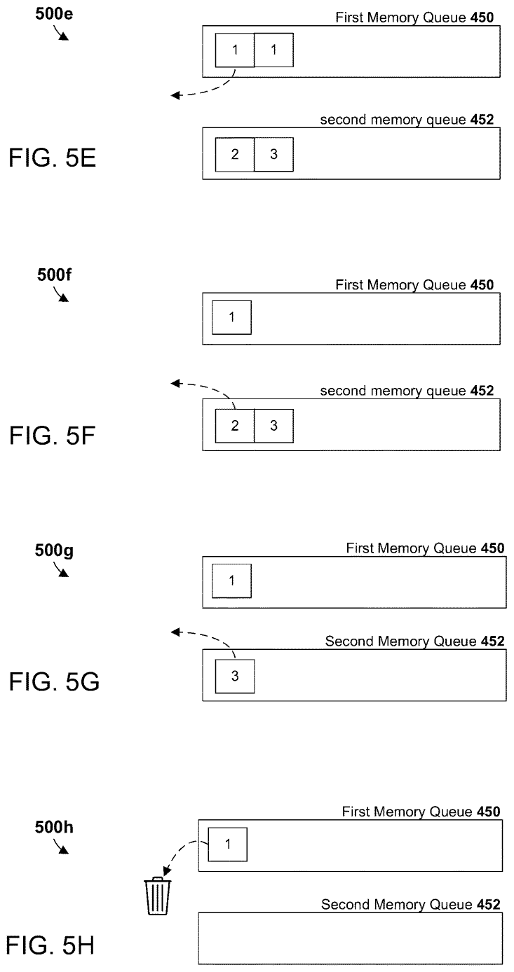

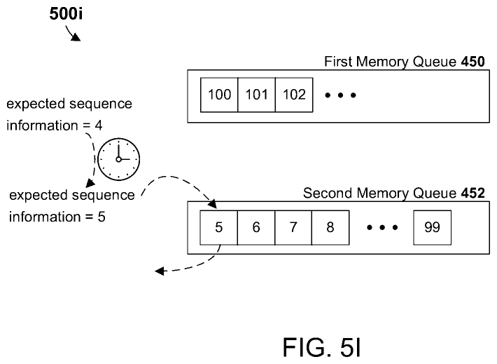

FIGS. 5A-5I are block diagrams illustrating memory operations 500a-500i that may be performed by a processor of a vehicle processing system for handling HD map data messages in message queues in accordance with some embodiments. With reference to FIGS. 1A-5I, memory operations 500a-500i may be performed by a processor (e.g., 207, 303, 304, 306, 307, 308, 310) of a vehicle processing system (e.g., 104, 200, 402, 420) that implements a first memory queue (e.g., 450) and a second memory queue (e.g., 452). The first memory queue 450 and the second memory queue 452 may be implemented in a vehicle processing system in software processing modules that execute in a vehicle computing device, within dedicated hardware modules within the vehicle, or in combinations of software processing modules and dedicated hardware modules that make up the vehicle processing system.

In operation 500a, the vehicle processing system may receive in the first memory queue 450 a plurality of HD map data messages each including sequence information (e.g., 0, 3, 2, 1, 1). In some embodiments, the vehicle processing system may first determine whether the second priority queue 452 has any HD map data messages stored. In response to determining that the second priority queue 452 does not have any HD map data messages stored, the vehicle processing system may determine whether the first memory queue 450 has any messages stored. In some embodiments, the vehicle processing system may repeat the determination of whether the second priority queue 452 and/or the first priority queue 450 have any HD map data messages stored.

In operation 500b, the vehicle processing system may handle (obtain, process) the first HD map data message stored in the first memory queue 450. In some embodiments, the vehicle processing system may determine sequence information of the first HD map data message. In some embodiments, the vehicle processing system may set in a data structure or in memory expected sequence information (e.g., an expected sequence number). In some embodiments, the expected sequence information may be represented as expected_seq_no or another suitable flag, string, information element, or the like. In some embodiments, the expected sequence information may represent sequence information that the vehicle processing system expects in a next HD map data message subsequent to the first HD map data message. For example, if the sequence information in the first HD map data message is “0,” the vehicle processing system may determine the expected sequence information to be n+1, in this case, “1”.

In operation 500c, the vehicle processing system may handle (obtain, process) a next HD map data message from the first memory queue 450. In some embodiments, the vehicle processing system may handle the next HD map data message from the first memory queue 450 in response to determining that no HD map data messages are stored in the second memory queue 452. The vehicle processing system may determine sequence information in the next HD map data message (e.g., “3”). In some embodiments, the vehicle processing system may compare the determined sequence information of the next HD map data message and the expected sequence information. In response to determining that the expected sequence information is less than the determined sequence information of the next HD map data message (e.g., 1<3), the vehicle processing system may store the next HD map data message in the second memory queue 452.

In operation 500d, the vehicle processing system may handle (obtain, process) a next HD map data message from the first memory queue 450. In some embodiments, the vehicle processing system may handle the next HD map data message from the first memory queue 450 in response to determining that the second memory queue 452 is not storing an HD map data message that matches the expected sequence information. The vehicle processing system may determine sequence information in the next HD map data message (e.g., “2”). In some embodiments, the vehicle processing system may compare the determined sequence information of the next HD map data message and the expected sequence information. In response to determining that the expected sequence information is less than the determined sequence information of the next HD map data message (e.g., 1<2), the vehicle processing system may store the next HD map data message in the second memory queue 452. The second memory queue 452 now stores two HD map data messages, one having sequence information “3” and one having sequence information “2”. The second memory queue 452 is configured to store the HD map data message having the sequence information “2” despite that HD map data message being handled after the HD map data message having the sequence information “3”. In this manner, the second memory queue 452 stores HD map data messages according to their respective sequence information. In some embodiments, the second memory queue 452 may be configured to handle HD map data message sequence information as priority information of the HD map data messages.

In operation 500e, the vehicle processing system may handle (obtain, process) a next HD map data message from the first memory queue 450. In some embodiments, the vehicle processing system may handle the next HD map data message from the first memory queue 450 in response to determining that the second memory queue 452 is not storing an HD map data message that matches the expected sequence information. The vehicle processing system may determine sequence information in the next HD map data message (e.g., “1”). The vehicle processing system may compare the determined sequence information of the next HD map data message and the expected sequence information. In response to determining that the sequence information of the next HD map data message matches the expected sequence information (e.g., 1=1), the vehicle processing system may process the next HD map data message from the first memory queue 450. The vehicle processing system may increment or update the expected sequence information (e.g., to “2”).

In operation 500f, the vehicle processing system may handle (obtain, process) a next HD map data message from the second memory queue 452 in response to determining that the second memory queue 452 is storing an HD map data message that matches the expected sequence information (e.g., 2=2). The vehicle processing system may increment or update the expected sequence information (e.g., to “3”).

In operation 500g, the vehicle processing system may handle (obtain, process) a next HD map data message from the second memory queue 452 in response to determining that the second memory queue 452 is storing an HD map data message that matches the expected sequence information (e.g., 3=3). The vehicle processing system may increment or update the expected sequence information (e.g., to “4”).

In operation 500h, the vehicle processing system may handle (obtain, process) a next HD map data message from the first memory queue 450. In some embodiments, the vehicle processing system may handle the next HD map data message from the first memory queue 450 in response to determining that the second memory queue 452 is not storing an HD map data message that matches the expected sequence information. The vehicle processing system may determine sequence information in the next HD map data message (e.g., “1”). In some embodiments, the vehicle processing system may compare the determined sequence information of the next HD map data message and the expected sequence information. In response to determining that the sequence information is less than the expected sequence information (e.g., 1<4), the vehicle processing system may discard (delete, ignore, refrain from processing) the next HD map data message.

In operation 500i, in some embodiments, the vehicle processing system may be configured to perform operations to address a scenario in which neither sequence information in a HD map data message stored in the first memory queue 450 nor sequence information in a the second memory queue 452 matches the expected sequence information. For example, an HD map data message may be lost in transit from the network computing device to the vehicle processing system. In some embodiments, the vehicle processing system may start a timer after receiving one or more HD map data messages in the first memory queue 450. In such embodiments, each time that the vehicle processing system determines that sequence information of an HD map data message stored in the second memory queue 452 or the first memory queue 450 matches the expected sequence information, the vehicle processing system may reset the timer.

If an HD map data message has been lost in transit, the vehicle processing system may be unable to find an HD map data message having sequence information that matches the expected sequence information in either the first memory queue 450 or the second memory queue 452. For example, the expected sequence information may be “4”, but the second memory queue 452 stores HD map data messages having sequence information “5”, “6”, “7”, “8” . . . “99”, and of the first memory queue 450 stores HD map data messages having sequence information “100”, “101”, “102”, etc. The HD map data message having the sequence information “4” has been lost in transit. In order to avoid a scenario in which the vehicle processing system waits infinitely for the lost packet, the vehicle processing system may start a timer after receiving one or more HD map data messages in the first memory queue 450. In response to determining that the sequence information of an HD map data message stored in either of the first memory queue or the second memory queue matches the expected sequence information before the timer expires, the vehicle processing system may select (obtain, process) the HD map data message having sequence information that matches the expected sequence information, and the vehicle processing system may reset the timer.

In response to the second timer expiring before the sequence information of an HD map data message stored in either of the first memory queue or the second memory queue matches the expected sequence information, the vehicle processing system may determine that the HD map data message having the sequence information “4” has been lost. The vehicle processing system may increment or increase the expected sequence information to the next sequence information after the lost HD map data message (e.g., to “5”). The vehicle processing system may then determine whether the second memory queue 452 stores and HD map data message having sequence information matching the expected sequence information, as further described above. For example, the vehicle processing system may determine that an HD map data message having the sequence information “5” that matches the expected sequence information (e.g., 5=5) is stored in the second memory queue 452, and the vehicle processing system may handle (obtain, process) the next HD map data message from the second memory queue 452, as described.

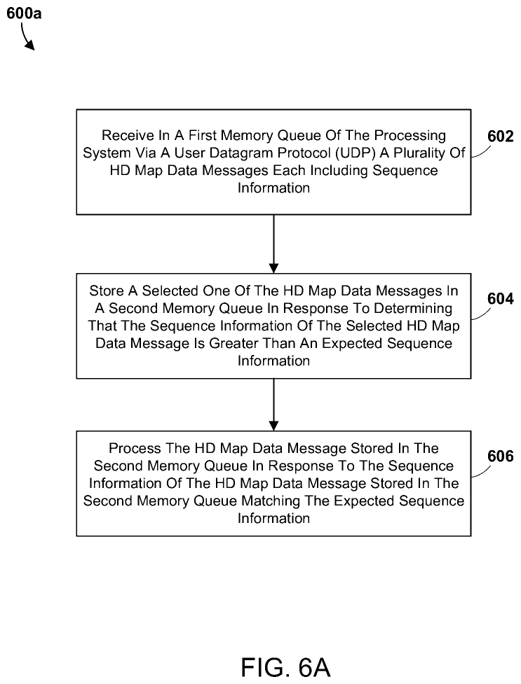

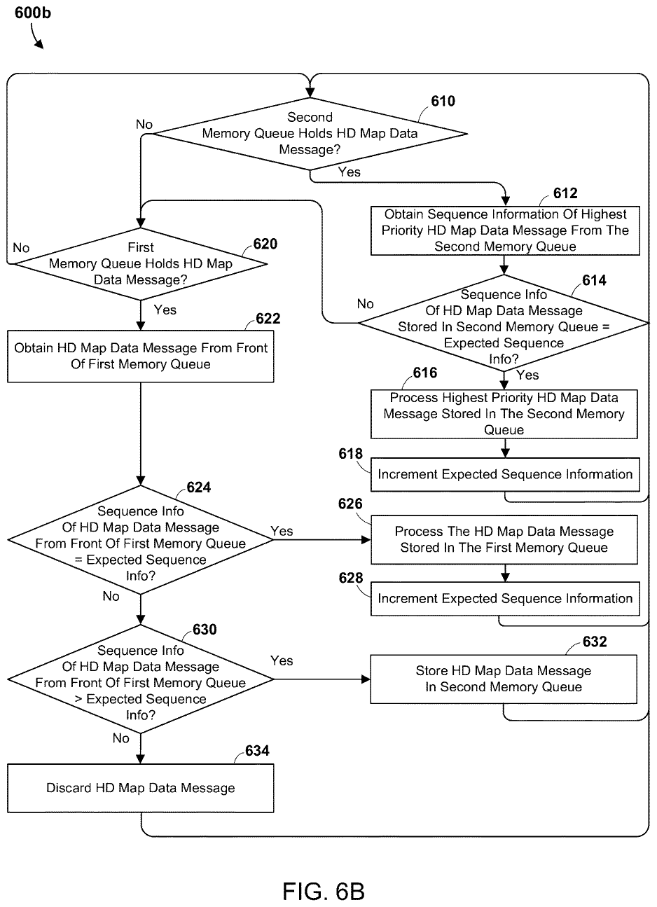

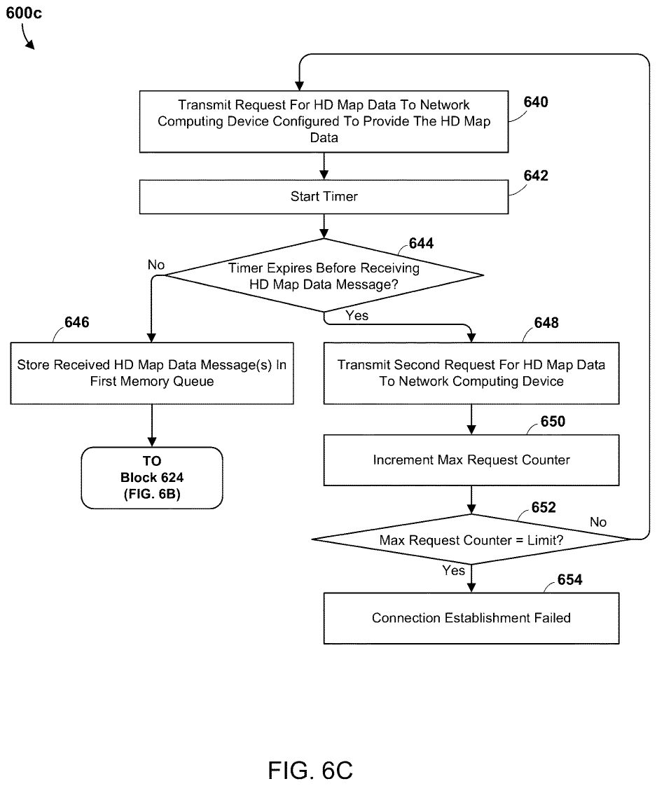

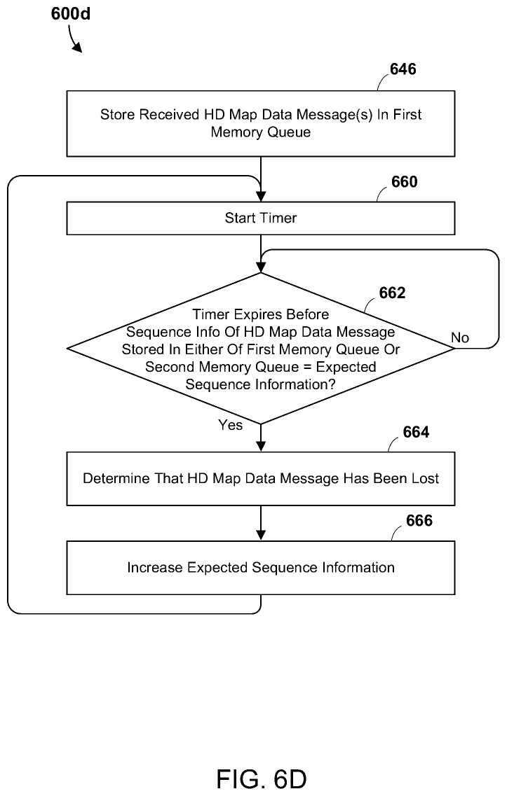

FIG. 6A is a process flow diagram of an example method 600a that may be performed by a processor of a vehicle processing system in a vehicle for handling HD map data messages in accordance with various embodiments. With reference to FIGS. 1A-6A, the operations of the method 600a may be performed by a processor (e.g., 207, 303, 304, 306, 307, 308, 310) of a vehicle processing system (e.g., 104, 200, 402, 420) that may be implemented in hardware elements, software elements, or a combination of hardware and software elements, and is referred to generally as a “processor.”

In block 602, the processor may receive in a first memory queue of the processing system via a User Datagram Protocol (UDP) a plurality of HD map data messages each comprising sequence information as described.

In block 604, the processor may determining whether the sequence information of one of the HD map data messages a message is greater than an expected sequence information and store the selected HD map data selected in a second memory queue in response to determining that the sequence information of the selected HD map data message is greater than an expected sequence information. In some embodiments, the processor may keep track of the sequence number of received HD map data messages (e.g., by buffering each sequence number or incrementing a sequence number counter), inspect the sequence information of each HD map data message as received, and store in the second memory queue any message in which the sequence information is out-of-sequence. For example, an HD map data message may be recognized as out of sequence when a preceding message in the sequence has not been received.

Also as part of the operations in block 604, HD map data messages may be stored in the second memory queue in order of priority that is determined based on each message's sequence number. In some embodiments, messages with the lowest sequence number may be stored in the queue with the highest priority, messages with higher sequence numbers may be stored in the queue with decreasing priority consistent with increasing sequence numbers.

In block 606, the processor may process the HD map data message stored in the second memory queue in response to the sequence information of the HD map data message stored in the second memory queue matching the expected sequence information. For example, the processor keeping track of message sequence numbers may access and use an HD map data message that is stored in the second memory queue when that message's sequence number matches the sequence number that the processor is tracking, indicating it is the next message in the sequence.

FIG. 6B is a process flow diagram of an example method 600b performed by a processor of a vehicle processing system in a vehicle for handling HD map data messages in accordance with various embodiments. With reference to FIGS. 1A-6B, the operations of the method 600b may be performed by a processor (e.g., 207, 303, 304, 306, 307, 308, 310) of a vehicle processing system (e.g., 104, 200, 402, 420) that may be implemented in hardware elements, software elements, or a combination of hardware and software elements, and is referred to generally as a “processor.”

In determination block 610, the processor may determine whether the second memory queue holds (stores) an HD map data message. For example, the processor may determine whether there are any messages stored in the queue, such as by inspecting the contents of the queue or a memory location of the queue memory pointer.

In response to determining that the second memory queue holds an HD map data message (i.e., determination block 610=“Yes”), the processor may obtain (i.e., determine, access) sequence information of a highest priority HD map data message from the second memory queue in block 612. For example, if there are multiple messages stored in the second memory queue, the processor may identify sequence information of the HD map data message with the highest priority (i.e., lowest sequence number) and access that message (e.g., pop the message off the queue memory stack).

In determination block 614, the processor may determine whether the obtained sequence information of the highest priority message in the second memory queue matches the expected sequence information.

In response to determining that the obtained sequence information of the highest priority message in the second memory queue matches the expected sequence information (i.e., determination block 614=“Yes”), the processor may process the HD map data message stored in the second memory queue (i.e., the highest priority HD map data message in the second memory queue) in block 616.

In block 618, the processor may increment the expected sequence information. For example, the processor may increase a value of an expected sequence number of an HD map data message or other suitable information. For example, having obtained for processing the highest priority (lowest sequence number) HD map data message, the processor may update the expected sequence number in a counter that tracks messages processed in sequence order to reflect (indicate) that the selected HD map data message has been processed. In some embodiments, the expected sequence information may be set to one more than the sequence number of the selected HD map data message to indicate the next message in the sequence that the processor should receive.

In response to determining that the second memory queue does not hold an HD map data message (i.e., determination block 610=“No”), or in response to determining that the sequence information of the highest priority message and the second memory queue does not match the expected sequence information (i.e., determination block 614=“No”), the processor may determine whether the first memory queue holds an HD map data message in determination block 620.

In response to determining that the first memory queue holds an HD map data message (i.e., determination block 620=“No”), the processor may determine whether the second memory queue holds (stores) an HD map data message in determination block 610 as described.

In response to determining that the first memory queue holds an HD map data message (i.e., determination block 620=“Yes”), the processor may obtain (i.e., select and access) an HD map data message from the front or top (i.e., first out) of the first memory queue in block 622.

In determination block 624, the processor may determine whether the sequence information of the HD map data message from the front of the first memory queue matches the expected sequence information.

In response to determining that the sequence information of the HD map data message from the front of the first memory queue matches the expected sequence information (i.e., determination block 624=“Yes”), the processor may process the HD map data message from the front of the first memory queue in block 626.

In block 628, the processor may increment the expected sequence information. For example, the processor may increase a value of an expected sequence number of an HD map data message or other suitable information. For example, having processed the HD map data message from the front of the first memory queue, the processor may update the expected sequence number in a counter that tracks messages processed in sequence order to reflect (indicate) that the selected HD map data message has been processed. In some embodiments, the expected sequence information may be set to one more than the sequence number of the selected HD map data message to indicate the next message in the sequence that the processor should receive.

In response to determining that the sequence information of the HD map data message from the front of the first memory queue does not match the expected sequence information (i.e., determination block 624=“No”), the processor may determine whether the sequence information of the HD map data message from the front of the first memory queue is greater than the expected sequence information in determination block 630.

In response to determining that the sequence information of the HD map data message from the front of the first memory queue is greater than the expected sequence information (i.e., determination block 630=“Yes”), the processor may store the HD map data message in the second memory queue in block 632.

In response to determining that the sequence information of the HD map data message from the front of the first memory queue is not greater than the expected sequence information (i.e., determination block 630=“No”), the processor may discard (ignore, refrain from processing) the HD map data message in block 634.

In response to determining that the first memory queue does not hold an HD map data message (i.e., determination block 620=“No”), or after completing operations in blocks 618, 628, 632, or 634, the processor may repeat the operations of determination block 610 and repeat the operations of the method 600b as described.

FIG. 6C is a process flow diagram of example operations 600c that may be performed by a processor of a vehicle processing system in a vehicle as part of the method 600a or 600b for handling HD map data messages in accordance with various embodiments. With reference to FIGS. 1A-6C, the operations 600c may be performed by a processor (e.g., 207, 303, 304, 306, 307, 308, 310) of a vehicle processing system (e.g., 104, 200, 402, 420) that may be implemented in hardware elements, software elements, or a combination of hardware and software elements, and is referred to generally as a “processor.”

In block 640, the processor may transmit a request for HD map data to a network computing device that is configured to provide the HD map data (e.g., the network computing device 404).

In block 642, the processor may start a timer.

In determination block 644, the processor may determine whether the timer expires before the processor receives an HD map data message.

In response to determining that the timer does not expire before the processor receives an HD map data message (i.e., determination block 644=“No”), the processor may store the received HD map data message (or messages) in the first memory queue in block 646, and then perform the operations of block 624 of the method 600b as described.

In response to the timer expiring before the processor receives an HD map data message (i.e., determination block 644=“Yes”), the processor may transmit a second request for HD map data to the network computing device in block 648.

In block 650, the processor may increment a maximum request counter.

In determination block 652, the processor may determine whether the maximum request counter meets a limit, such as a maximum number of requests.

In response to determining that the maximum request counter does not meet the limit (i.e., determination block 652=“No”), the processor may transmit another request for HD map data to the network computing device in block 640 as described.

In response to determining that the maximum request counter meets the limit (i.e., determination block 652=“Yes”), the processor may determine that connection establishment with the network computing device has failed in block 654, enabling the processor to perform operations to reestablish a connection to the network.

FIG. 6D is a process flow diagram of example operations 600d that may be performed by a processor of a vehicle processing system in a vehicle as part of the methods and operations 600a, 600b, and/or 600c for handling HD map data messages in accordance with some embodiments. With reference to FIGS. 1A-6D, the operations 600d may be performed by a processor (e.g., 207, 303, 304, 306, 307, 308, 310) of a vehicle processing system (e.g., 104, 200, 402, 420) that may be implemented in hardware elements, software elements, or a combination of hardware and software elements, and is referred to generally as a “processor.”

In some embodiments, the vehicle processing system may be configured to perform operations to address a scenario in which neither sequence information in a HD map data message stored in the first memory queue (e.g., 450) nor sequence information in a the second memory queue (e.g., 452) matches the expected sequence information. This may happen, for example, when an HD map data message is lost or irretrievably corrupted in transit from the network computing device to the vehicle processing system.

In block 646, the processor may store received HD map data message(s) in the first memory queue in a manner similar to the operations in block 604 of the method 600a as described.

In block 660, the processor may start a timer (in some embodiments, a second timer).

In determination block 662, the processor may determine whether the timer expires before sequence information of an HD map data message stored in either of the first memory queue or the second memory queue matches the expected sequence information.

In response to determining that the timer has not expired when sequence information of an HD map data message stored in either of the first memory queue or the second memory queue matches expected sequence information (i.e., determination block 662=“No”), the processor may continue to monitor the timer and perform the operations of determination block 662 as described.

In response to the timer expiring before sequence information of an HD map data message stored in either of the first memory queue or the second memory queue matches expected sequence information (i.e., determination block 662=“Yes”), the processor may determine that an HD map data message has been lost in block 664. In some embodiments, the processor may determine that an HD map data message having sequence information that matches the expected sequence information has been lost.

In block 666, the processor may increment or otherwise increase the expected sequence information. For example, the processor may increment or update the expected sequence number so that the processor looks to receive the next message in the sequence, thus skipping the lost message.

The processor may restart another timer in block 660 and perform the operations in determination block 662, 664 and 666 until an HD map data message with expected sequence information is received, thereby skipping lost messages until reception of messages in sequence order is reestablished.

Implementation examples are described in the following paragraphs. While some of the following implementation examples are described in terms of example methods, further example implementations may include: the example methods discussed in the following paragraphs implemented by a vehicle processing system that may be an on-board unit, mobile device unit, or mobile computing unit, or a processing system of a network computing device, including a processor configured with processor-executable instructions to perform operations of the methods of the following implementation examples; the example methods discussed in the following paragraphs implemented by a vehicle processing system including means for performing functions of the methods of the following implementation examples; and the example methods discussed in the following paragraphs may be implemented as a non-transitory processor-readable storage medium having stored thereon processor-executable instructions configured to cause a processor of a vehicle processing system to perform the operations of the methods of the following implementation examples.

Example 1. A method of handling high definition (HD) map data messages by a processing system of a vehicle, including receiving in a first memory queue of the processing system via a User Datagram Protocol (UDP) a plurality of HD map data messages each including sequence information, storing a selected one of the HD map data messages in a second memory queue in response to determining that the sequence information of the selected HD map data message is greater than an expected sequence information, and processing the HD map data message stored in the second memory queue in response to the sequence information of the HD map data message stored in the second memory queue matching the expected sequence information.

Example 2. The method of example 1, further including determining whether the second memory queue holds an HD map data message, and determining whether an HD map data message stored in the second memory queue matches the expected sequence information in response to determining that the second memory queue holds an HD map data message.

Example 3. The method of example 2, further including processing the HD map data message stored in the first memory queue in response to either determining that the second memory queue does not hold an HD map data message or determining that the sequence information of the HD map data message stored in the second memory queue does not match the expected sequence information.

Example 4. The method of any of examples 1-3, further including discarding the selected one of the HD map data messages in response to determining that the sequence information of the selected HD map data message is less than the expected sequence information.

Example 5. The method of any of examples 1-4, in which receiving in the first memory queue of the processing system via UDP the plurality of HD map data messages each including sequence information includes transmitting a request for HD map data to an Electronic Horizon Provider, and receiving the plurality of HD map data messages in response to the request for the HD map data.

Example 6. The method of any of examples 1-5, further including starting a first timer after transmitting a request for HD map data to a network computing device configured to provide the HD map data, and transmitting a second request for HD map data to the network computing device in response to the first timer expiring before receiving an HD map data message.

Example 7. The method of any of examples 1-6, further including starting a second timer after receiving in the first memory queue of the processing system the plurality of HD map data messages, and determining that an HD map data message has been lost in response to the second timer expiring before the sequence information of an HD map data message stored in either of the first memory queue or the second memory queue matches the expected sequence information.

Example 8. The method of any of examples 1-7, in which the second memory queue includes a priority queue, and the sequence information of each of the HD map data messages stored in the second memory queue is processed as priority information of each of the HD map data messages stored in the second memory queue.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of handling high definition (HD) map data messages by a processing system of a vehicle, comprising:
receiving in a first memory queue of the processing system via a User Datagram Protocol (UDP) a plurality of HD map data messages each comprising sequence information;
storing a selected one of the HD map data messages in a second memory queue in response to determining that the sequence information of the selected HD map data message is greater than an expected sequence information; and
processing the HD map data message stored in the second memory queue in response to the sequence information of the HD map data message stored in the second memory queue matching the expected sequence information.

2. The method of claim 1, further comprising:
determining whether the second memory queue holds an HD map data message; and
determining whether an HD map data message stored in the second memory queue matches the expected sequence information in response to determining that the second memory queue holds an HD map data message.

3. The method of claim 2, further comprising processing the HD map data message stored in the first memory queue in response to either determining that the second memory queue does not hold an HD map data message or determining that the sequence information of the HD map data message stored in the second memory queue does not match the expected sequence information.

4. The method of claim 1, further comprising discarding the selected one of the HD map data messages in response to determining that the sequence information of the selected HD map data message is less than the expected sequence information.

5. The method of claim 1, wherein receiving in the first memory queue of the processing system via UDP the plurality of HD map data messages each comprising sequence information comprises:
transmitting a request for HD map data to an Electronic Horizon Provider; and
receiving the plurality of HD map data messages in response to the request for the HD map data.

6. The method of claim 1, further comprising:
starting a first timer after transmitting a request for HD map data to a network computing device configured to provide the HD map data; and
transmitting a second request for HD map data to the network computing device in response to the first timer expiring before receiving an HD map data message.

7. The method of claim 1, further comprising:
starting a second timer after receiving in the first memory queue of the processing system the plurality of HD map data messages; and
determining that an HD map data message has been lost in response to the second timer expiring before the sequence information of an HD map data message stored in either of the first memory queue or the second memory queue matches the expected sequence information.

8. The method of claim 1, wherein the second memory queue comprises a priority queue, and the sequence information of each of the HD map data messages stored in the second memory queue is processed as priority information of each of the HD map data messages stored in the second memory queue.

9. A vehicle processing system, comprising:
a processor configured with processor-executable instructions to:
receive in a first memory queue of the processing system via a User Datagram Protocol (UDP) a plurality of HD map data messages each comprising sequence information;
store a selected one of the HD map data messages in a second memory queue in response to determining that the sequence information of the selected HD map data message is greater than an expected sequence information; and
process the HD map data message stored in the second memory queue in response to the sequence information of the HD map data message stored in the second memory queue matching the expected sequence information.

10. The vehicle processing system of claim 9, wherein the processor is further configured with processor-executable instructions to:
determine whether the second memory queue holds an HD map data message; and
determine whether an HD map data message stored in the second memory queue matches the expected sequence information in response to determining that the second memory queue holds an HD map data message.

11. The vehicle processing system of claim 10, wherein the processor is further configured with processor-executable instructions to process the HD map data message stored in the first memory queue in response to either determining that the second memory queue does not hold an HD map data message or determining that the sequence information of the HD map data message stored in the second memory queue does not match the expected sequence information.

12. The vehicle processing system of claim 9, wherein the processor is further configured with processor-executable instructions to discard the selected one of the HD map data messages in response to determining that the sequence information of the selected HD map data message is less than the expected sequence information.

13. The vehicle processing system of claim 9, wherein the processor is further configured with processor-executable instructions to:
transmit a request for HD map data to an Electronic Horizon Provider; and
receive the plurality of HD map data messages in response to the request for the HD map data.

14. The vehicle processing system of claim 9, wherein the processor is further configured with processor-executable instructions to:
start a first timer after transmitting a request for HD map data to a network computing device configured to provide the HD map data; and
transmit a second request for HD map data to the network computing device in response to the first timer expiring before receiving an HD map data message.

15. The vehicle processing system of claim 9, wherein the processor is further configured with processor-executable instructions to:
start a second timer after receiving in the first memory queue of the processing system the plurality of HD map data messages; and
determine that an HD map data message has been lost in response to the second timer expiring before the sequence information of an HD map data message stored in either of the first memory queue or the second memory queue matches the expected sequence information.

16. The vehicle processing system of claim 9, wherein the processor is further configured with processor-executable instructions such that the second memory queue comprises a priority queue, and the sequence information of each of the HD map data messages stored in the second memory queue is processed as priority information of each of the HD map data messages stored in the second memory queue.

17. A vehicle processing system, comprising:
means for receiving in a first memory queue of the processing system via a User Datagram Protocol (UDP) a plurality of HD map data messages each comprising sequence information;
means for storing a selected one of the HD map data messages in a second memory queue in response to determining that the sequence information of the selected HD map data message is greater than an expected sequence information; and
means for processing the HD map data message stored in the second memory queue in response to the sequence information of the HD map data message stored in the second memory queue matching the expected sequence information.

18. The vehicle processing system of claim 17, further comprising:
means for determining whether the second memory queue holds an HD map data message; and
means for determining whether an HD map data message stored in the second memory queue matches the expected sequence information in response to determining that the second memory queue holds an HD map data message.

19. The vehicle processing system of claim 18, further comprising means for processing the HD map data message stored in the first memory queue in response to either determining that the second memory queue does not hold an HD map data message or determining that the sequence information of the HD map data message stored in the second memory queue does not match the expected sequence information.

20. The vehicle processing system of claim 17, further comprising means for discarding the selected one of the HD map data messages in response to determining that the sequence information of the selected HD map data message is less than the expected sequence information.

21-30. (canceled)
